(19) United States
(12) Patent Application Publication
(10) Pub. No.: US 2014/0219074 A1
(43) Pub. Date: Aug. 7, 2014

(54) Adjusted Transmission in XDSL

(71) Applicants: Chenguang Lu, Sollentuna (SE); Miguel Berg, Upplands Väsby (SE); Per-Erik Eriksson, Stockholm (SE); Albin Johansson, Skellefteå (SE)

(72) Inventors: Chenguang Lu, Sollentuna (SE); Miguel Berg, Upplands Väsby (SE); Per-Erik Eriksson, Stockholm (SE); Albin Johansson, Skellefteå (SE)

(73) Assignee: TELEFONAKTIEBOLAGET L M ERICSSON (PUBL), Stockholm (SE)

(21) Appl. No.: 14/239,875

(22) PCT Filed: Aug. 24, 2011
(86) PCT No.: PCT/EP2011/064533

§ 371 Date: Mar. 31, 2014

(51) Int. Cl. H04B 3/32

(52) U.S. Cl. CPC H04B 3/32
USPC 370/201

(57) ABSTRACT

Method and transmitting node for adjusting transmission over xDSL lines connected to the transmitting node. The method involves transmitting (1006) a first signal A1 on a first line (304), and transmitting (1008) a second signal A2 on a second line (306), the second signal A2 being related to the first signal A1. The method further involves adjusting (1010) the transmission of the second signal A2 on the second line (306), such that a contribution from the second signal A2 interferes constructively with a signal A1′ at the second end (304:2) of the first line (304), where the signal A1′ represents the signal A1 having propagated through the first line.

### TECHNICAL FIELD

The invention relates to a method and transmitting node in a DSL (Digital Subscriber Line) system, in particular to adjusting the transmission on one or more of the DSL lines.

### BACKGROUND

DSL technologies provide a cost-effective broadband access solution by reusing the existing infrastructure of POTS (Plain Old Telephone Service) networks. Thus, DSL technologies have come to dominate the broadband access market.

FIG. 1a is a schematic view of a basic DSL system comprising N lines. A line is typically a twisted pair of copper wires. At the DSLAM (Digital Subscriber Line Access Multiplexer) side, a transceiver node 102 is connected to a respective first end of the N lines. The respective other end of the lines is typically connected to a so-called CPE or similar communication equipment.

The performance of DSL systems is limited by line attenuation and crosstalk. In FIG. 1b, FEXT (Far End cross-Talk) is illustrated as a dashed line from one line to another line. Basically, the reach (e.g. in meters) is mainly limited by line attenuation, while the capacity (e.g. in bits/s) is mainly limited by crosstalk from neighboring lines.

The work on further improving the performance of DSL systems is constantly in progress. For example, the use of the recently approved vectoring recommendation, ITU-T G.993.5, enables that crosstalk between DSL lines can be efficiently canceled, which may entail a significant improvement of DSL line capacity.

A new standardization work, ITU-T “G.fast”, has been started in order to enable DSL service from a last distribution point which is located as far as 200 meters away from a user. Within the work on G.fast it is considered to use frequencies of up to 300 MHz, which is higher than for example in current VDSL2 (Very-high-bitrate DSL) systems, where only frequencies of up to 30 MHz are used.

### SUMMARY

It would be desirable to improve the performance of xDSL systems in terms of e.g. reach and capacity. It is an object of the invention to enable improved xDSL system performance.

According to a first aspect, a method is provided in a transmitting node connected to a respective first end of a first and a second digital subscriber line, where the second end of the first line is connected to a first receiving node. The method comprises transmitting a first signal A1 on the first line, and transmitting a second signal A2 on the second line, the second signal A2 being related to the first signal A1. The method further comprises adjusting the transmission of the second signal A2 on the second line, such that a contribution from the second signal A2 interferes constructively with a signal A1′ at the second end of the first line, where the signal A1′ represents the signal A1 having propagated through the first line.

According to a second aspect, a transmitting node for digital subscriber lines is provided. The transmitting node is connectable to a respective first end of at least a first and a second digital subscriber line. The transmitting node comprises a functional unit, which is adapted to transmit a first signal A1 on the first line; and to transmit a second signal A2 on the second line, where the second signal A2 is related to the first signal A1. The transmitting node further comprises a functional unit, adapted to adjust the transmission of the second signal A2 on the second line such that a contribution from the second signal A2 interferes constructively with a signal A1′ at the second end of the first line, where the signal A1′ represents the signal A1 having propagated through the first line.

The above method and transmitting node may be used for extending the reach and improving the capacity on the lines which are subjected to/provided with constructive contributions from one or more neighboring DSL lines. Spare DSL lines could be used for creating constructive interference to other DSL lines. For example, in some countries, the POTS network comprises two DSL lines to each potential subscriber, of which one line is typically idle. Further, DSL lines which are e.g. connected to another receiving node, but which are not presently used, or only used in a certain frequency band, could be used for creating constructive interference to other DSL lines in frequencies currently unused by a DSL or POTS customer.

The above method and transmitting node may be implemented in different embodiments. In most embodiments the contribution from the second signal A2 is crosstalk related to the second signal A2 from the second line to the first line. The adjusting may be performed by use of precoding. The second signal may be transmitted on/using one or more subcarriers, and may comprise the same information or data, or at least part thereof, as the first signal on the corresponding respective subcarriers

Further, the second end of the second line could e.g. be connected to a second receiving node or be idle. The adjusting of the transmission of the second signal A2 on the second line could be based on feedback received from the first receiving node, and/or upstream communication from the first receiving node.

Unwanted crosstalk to the first DSL line from one or more other DSL lines could be cancelled by use of vectoring.

The embodiments above have mainly been described in terms of a method. However, the description above is also intended to embrace embodiments of the transmitting node, adapted to enable the performance of the above described features. The different features of the exemplary embodiments above may be combined in different ways according to need, requirements or preference.

### BRIEF DESCRIPTION OF THE DRAWINGS

The invention will now be described in more detail by means of exemplifying embodiments and with reference to the accompanying drawings, in which:

FIG. 1a is a schematic view illustrating a basic DSL system.

FIG. 1b is a schematic view illustrating FEXT in a basic DSL system.

FIG. 2 is a schematic view of a DSL system where FEXT is utilized in accordance with an exemplifying embodiment.

FIG. 3 is a schematic view of a DSL system comprising a transmitting node according to an exemplifying embodiment.

FIG. 4a-6 are schematic views illustrating multiple parallel coherent transmission systems in accordance with exemplifying embodiments.

FIG. 7 is a schematic view illustrating a device for increasing the coupling between lines.

FIG. 8a is a diagram showing the magnitude in dB of a direct channel of a first line and crosstalk (FEXT) channels from other lines to the first line, where all lines have a respective loop length of 200 meters.

FIG. 8b is a diagram showing the SNR for single line transmission as compared to that of coherent transmission, according to an exemplifying embodiment, over a different number of lines.

FIG. 9 is a diagram illustrating capacity (bit rate) versus reach (loop length) for single line transmission and coherent transmission over a different number of lines.

FIG. 10 is a flow chart illustrating the actions in a procedure in a transmitting node according to an exemplifying embodiment.

FIGS. 11-12 are block diagrams illustrating a transmitting node according to exemplifying embodiments.

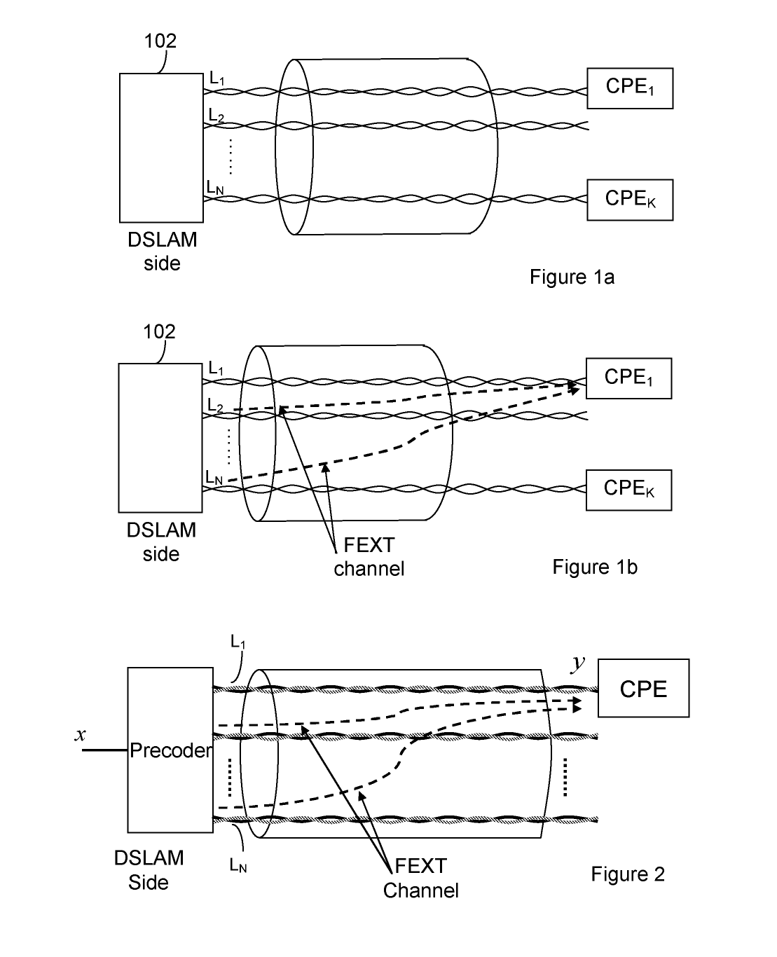

### DETAILED DESCRIPTION

Briefly described, a solution is presented where contributions/interference from information transmitted on one or more neighboring DSL lines is utilized for increasing the received signal power of a desired signal at a receiver connected to a certain DSL line.

Crosstalk between DSL lines is normally considered to be a problem, since the desired signal on each line is degenerated by such crosstalk. Therefore, much effort has been spent over the years on finding solutions for mitigation or cancellation of crosstalk between DSL lines. For example, as previously mentioned, so-called vectoring is a recommended solution for cancellation of crosstalk between DSL lines.

However, in this description, the property of crosstalk channels between DSL lines is exploited and utilized for increasing the received signal power of a desired signal on a line of interest, and thus enhancing said desired signal. This is achieved by that respective signals carrying, at least partly, the same data are transmitted both on a DSL line of interest and on a neighboring DSL line in such a way that the signal from the direct channel of the DSL line of interest and the signal carrying the same data from the crosstalk channel of said neighboring DSL line to the DSL line of interest are received constructively at a receiver connected to the DSL line of interest. Such a signal from a crosstalk channel will henceforth be referred to as “constructive crosstalk”. The signal carrying the same data is transmitted on at least one subcarrier (or tone) on the neighboring DSL line. The concept is not limited to use of only one neighboring DSL line for constructive crosstalk contribution to a DSL line of interest. The more constructive crosstalk contributions from other DSL lines, the more power gain to a desired signal on the DSL line of interest.

In other words, in order to achieve constructive crosstalk to a DSL line, L_{D}, of interest, the desired information/data that is transmitted on L_{D}, or parts thereof, is also to be transmitted on at least one other DSL line, L_{O}. The transmission on the at least one other DSL line, L_{O}, is further to be adjusted such that the crosstalk signal(s) from L_{O} to L_{O}, and a desired direct signal transmitted over L_{D} are in phase/coherent, and thus add constructively, at a receiver connected to L_{D}. Alternatively, for a two line case (one L_{O}-line), the transmission on L_{D} could be adjusted to add constructively with the crosstalk from L_{O}, or, the respective transmission on both lines could be adjusted to add constructively at the receiver connected to L_{O}.

It should be noted that the transmission technique used in the DSL systems discussed above is assumed to be OFDM/DMT, and that transmission may be performed on any set or sub-set of the plurality of subcarriers/tones. Thus, constructive crosstalk could be achieved for a selected set of tones, e.g. one, a few, several or all of the tones used for transmission on line L_{D} and available for transmission on line(s) L_{O}. The signal modulated on a tone on line L_{O} in order to create constructive crosstalk to a corresponding tone on line L_{D} is preferably a scaled version of the signal on the corresponding tone on L_{O}. That is, the data to be transmitted on a certain tone on line L_{O} in order to create constructive crosstalk is a copy of the data transmitted on the corresponding tone on L_{O}, which copy is subjected to a multiplication with a complex scaling factor prior to transmission.

As described above, the more constructive crosstalk contributions from other DSL lines L_{O}, the more power gain to a desired signal on a DSL line of interest L_{O}. Thus, in contrast to traditional DSL deployment, it may in some cases be desired to artificially increase coupling between lines e.g. by using galvanic connection or non-galvanic coupling (inductive, capacitive etc). An example of galvanic connection is to connect two lines in parallel at the CPE side. Further, an example of non-galvanic coupling is to connect two lines using a transformer. The transformer may have multiple primary windings where the different lines from the DSLAM side can be connected and at least one secondary winding where the line from the CPE side is connected. A device for artificial coupling enhancement may also include means for impedance matching since large impedance mismatches will decrease the power gain.

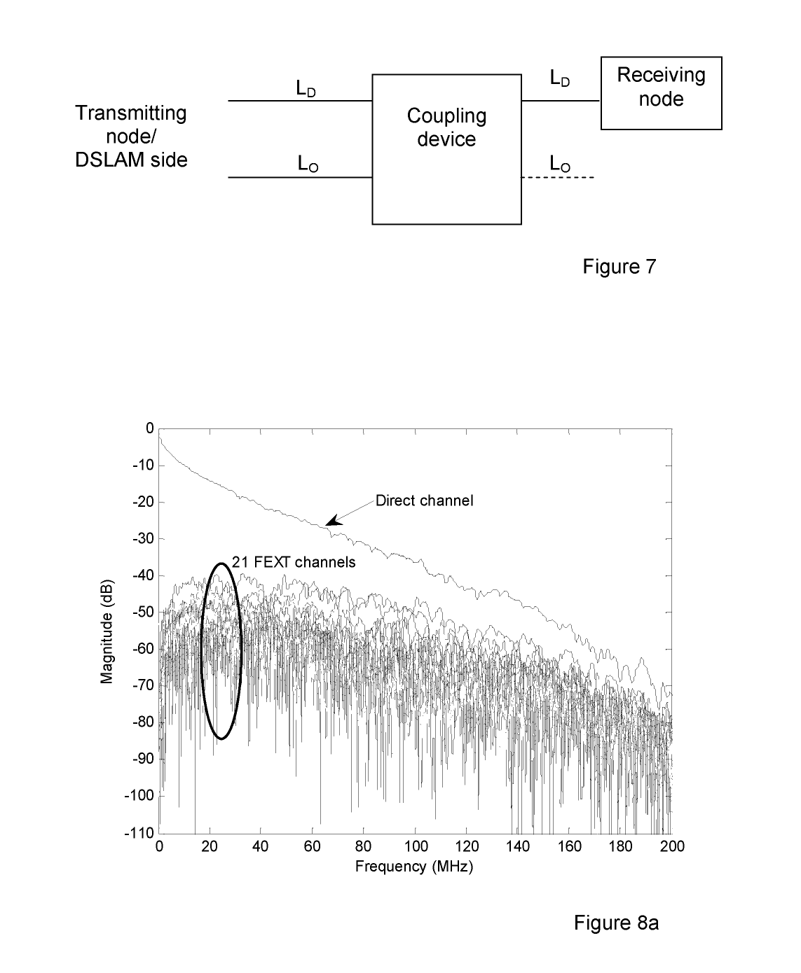

Examples of DSL arrangements with artificially increased coupling between lines could be e.g. when “another” DSL line L_{O} is in fact physically connected to/twined with the DSL line L_{O}, or, if L_{O} and L_{D} are connected through some coupling device, in or near the end where the signals are to add constructively, as previously described. The contribution from L_{O} to L_{D} in such arrangements could be regarded as “full crosstalk”, and the adjusting of the transmission over L_{O} could be performed as if the (major) contribution from L_{O} to L_{D} was substantial crosstalk, even though it in fact propagates through a galvanic connection or other type of coupling device as shown in FIG. 7. In FIG. 7, L_{O} is illustrated by a dashed line on the receiving-node-side of the coupling device to illustrate that L_{O} may terminate in the coupling device.

For an N-line DSL system, as exemplified in FIG. 2, assuming that “line 1”, L₁, is the line of interest, where a CPE is connected to one end (the “Far End”) of L₁, the received signal at one tone at the CPE side can be modelled as

y=h^{T}px+n (1)

where x denotes the transmitted signal before the precoder;
P=[p₁ p₂ . . . p_{N}]^{T} is the precoder vector in which pᵢ is the precoding coefficient for the signal transmitted on line i;
h=[h₁₁ h₁₂ . . . h_{1N}]^{T} denotes the channel vector in which h₁ᵢ is the channel coefficient from line i to line 1, and n denotes the noise at the CPE side. By noise is here meant unwanted distortion, such as thermal noise, Radio Frequency Interference (RFI) and/or undesired crosstalk from “alien” DSL systems/lines. The constructive crosstalk is not comprised in the noise term n.

To maximize the received signal strength at the CPE, and thus e.g. the possible bit rate, a Maximum Ratio Combining (MRC) technique is used to precode the signals. By precoding is meant that certain weights or operators are assigned to the transmission over the different tones of the different DSL lines, which weights may be expressed in a vector or matrix denoted a precoding vector or matrix. The i^{th} coefficient of the MRC precoding vector can be expressed as

$${p}_{i} = \frac{{h}_{1 i}^{*}}{\vert {h}_{1 i} \vert} \qquad ( 2 )$$

With MRC precoding in accordance with (2), the received signal may be expressed as:

$$y = {\sum }_{i} \vert {h}_{1 i} \vert x + n \qquad ( 3 )$$

Then, the power gain at the CPE side with respect to single line transmission over L1 can be expressed as:

$$g = \frac{{( {\sum }_{i} \vert {h}_{1 i} \vert )}^{2}}{{\vert {h}_{11} \vert}^{2}} \qquad ( 4 )$$

It can be seen in (4), that the stronger the crosstalk channel is and the higher the number of lines used, the higher power gain can be achieved. It should be noted that the power gain, in fact, can exceed the increase in transmit power. For example, if the crosstalk channel is equally strong as the direct channel, the power gain for 2 lines (one line creating constructive crosstalk to the other) is 6 dB and the power gain for 4 lines is 12 dB, while the transmit power is increased by 3 dB and 6 dB, respectively. The crosstalk level can be very high in DSL, especially in higher frequencies. Therefore, it is expected to achieve considerable power gain over multi-line channels by exploiting the crosstalk channel gain, as previously described.

Henceforth, the term “coherent transmission scheme” will be used as referring to a scheme where transmission on one or more DSL lines, L_{O} is adjusted such as to create constructive interference/crosstalk to a certain other DSL line, L_{O}. The transmission resulting in that a desired direct signal over L_{D} is received in phase/coherence with the signal from the crosstalk channel from L_{O} will be referred to as “coherent transmission”. Further, the term “coherent transmission system” or “coherent transmission set” will be used as referring to an arrangement comprising a “master” or “main” DSL line, L_{O}, and a set of one or more other DSL lines L_{O}, which are used for creating constructive crosstalk to a signal on the line L_{O}.

At the presence of more than one coherent transmission system in a DSL system, or e.g. one coherent transmission system and one or more single line transmission system (i.e. a direct DSL line which is not supported by constructive crosstalk from other DSL lines), vectoring can be used to cancel out the crosstalk between the different systems. FIG. 4b illustrates a DSL system comprising two coherent transmission systems: a first coherent transmission system comprising DSL lines L₁ and L₂, and a second coherent transmission system comprising DSL lines L₃ and L₄. DSL line L₁ is connected to a first CPE, CPE₁, and DSL line L₃ is connected to a second CPE, CPE₂. DSL lines L₂ and L₄ are assumed to be available for coherent transmission. The lines L₂ and L₄ could be idle/unconnected at the far end, or, could alternatively be connected e.g. to a respective CPE or similar equipment, which is not in use, or used e.g. only in part(s) of the frequency spectrum.

In FIG. 4b, lines L₁ and L₂ are used for a signal intended for CPE₁, while lines L₃ and L₄ are used for a signal intended for CPE₂. However, there will also be unwanted crosstalk, e.g. from L₃ and L₄ to L₁ and L₂. Vectoring may be used to cancel such unwanted crosstalk between e.g. a first and a second coherent transmission system. The transmission over the DSL lines illustrated in FIG. 4b should thus be adjusted, preferably by use of a so-called precoder, such that power gain from constructive crosstalk is achieved within the first and second coherent transmission system, while unwanted crosstalk between the first and second coherent transmission system is cancelled out. This combination of constructive addition of signals and cancelling of unwanted crosstalk can be achieved e.g. by combining MRC (Maximum Ratio Combining) and ZF (Zero-forcing) techniques.

A precoder, P, to be used in a transmitter node in a DSL system for constructive addition and cancelling of unwanted crosstalk as described above, could be regarded as comprising two parts, P_{c} and Pᵥ, as:

P=P_{c}Pᵥ (5)

where P_{c} denotes a combining matrix for coherent transmission and Pᵥ denotes a vectoring matrix for crosstalk cancellation.

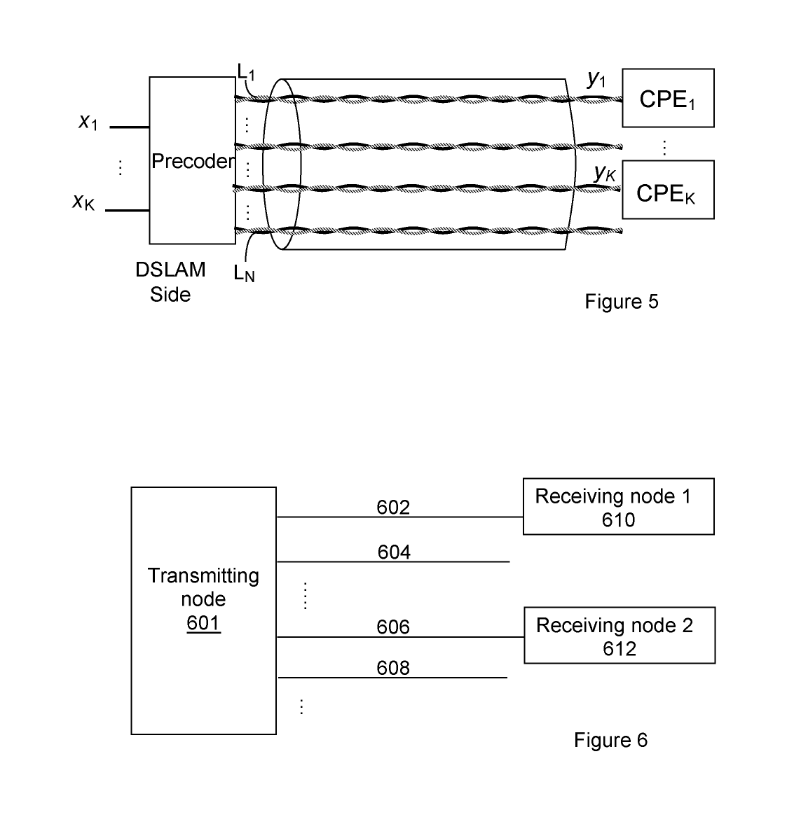

Assume an N-line system, as illustrated in FIG. 5, where there are K coherent transmission systems intended for a respective one of K CPEs, where the i^{th} coherent transmission system comprises/transmits on Nᵢ lines. The received signal vector at one tone at the CPE side can then be modeled as

y=HP_{c}Pᵥx+n (6)

where y=[y₁ y₂ . . . y_{K}]^{T} in which yᵢ denotes the received signal at CPE i;
x=[x₁ x₂ . . . x_{K}]^{T} is the transmit signal vector before the precoder, where xᵢ denotes the signal destined for CPE i; Pᵥ is a K×K square matrix for vectoring;
P_{c} is a N×K matrix for coherent transmissions; H is the channel matrix which is a K×N matrix where the element at row i and column j, hᵢⱼ, denotes the channel coefficient from the transmitter at line j to the receiver at line i, and n=[n₁ n₂ . . . n_{K}]^{T} is the noise vector at the CPE side in which n, denotes the noise (e.g. thermal noise) at CPE

In order to achieve a power gain to a desired signal by contribution from constructive crosstalk, the element pᵢⱼ^{c}, at row i and column j of the combing matrix P_{c}, can be set as:

$${p}_{ij}^{c} = \{ \begin{matrix}\frac{{h}_{ji}^{*}}{\vert {h}_{ji} \vert} & if {x}_{j} is transmitted on line i \\ 0 & otherwise .\end{matrix} \qquad ( 7 )$$

To cancel out the crosstalk between the signals intended for different CPEs, the vectoring matrix Pᵥ can be configured as

$${P}_{v} = \frac{1}{β} {\tilde{H}}^{- 1} {\tilde{H}}_{d} \qquad ( 8 )$$

where \tilde{H}=HP_{c} is defined as the equivalent channel for vectoring; \tilde{H}_{d} is the diagonal matrix of \tilde{H}, and β is the power normalization factor which can be set as:

β=maxᵢ∥[\tilde{H}⁻¹\tilde{H}_{d}]_{row i}∥ (9)

where ∥[A]_{row i}∥ denotes the Euclidean norm of the i^{th} row vector of A. This vectoring precoder may also be referred to as a normalized diagonal precoder. In this way, a similar gain as shown in equation (4) can be achieved in a vectored coherent transmission system.

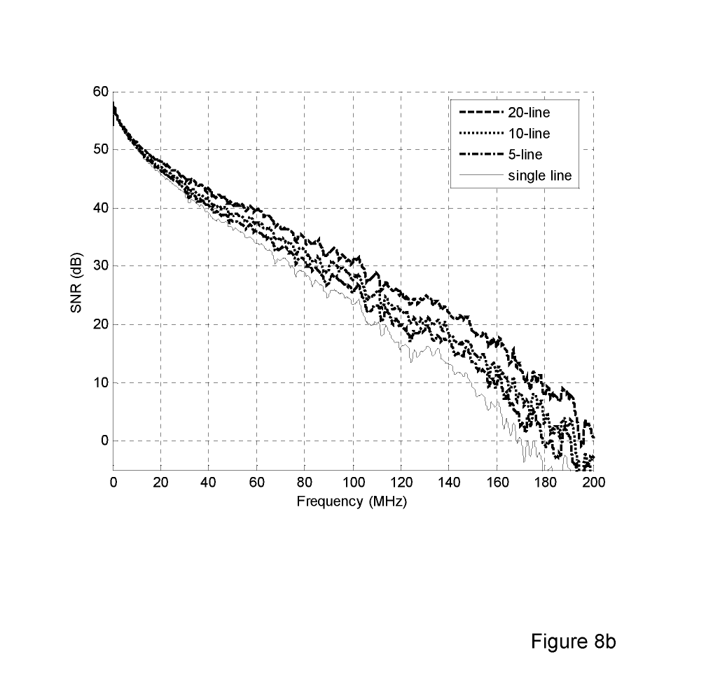

FIG. 8a shows a diagram of the measured channel of a 22 lines, 0.5 mm, 200 meters cable. In FIG. 8a it can be seen that the crosstalk channels get closer to the direct channel as frequency increases, which indicates that the power gain from coherent transmission will probably increase with increased frequency.

FIG. 8b shows the simulated SNR achieved by “coherent transmission” on a different number of lines on the 200 meters cable illustrated in FIG. 8a. In the simulation, it was assumed −80 dBm/Hz signal PSD (Power Spectral Density) and −140 dBm/Hz noise floor. The results illustrated in FIG. 8b show that significant SNR gain can be achieved by coherent transmission, especially at higher frequencies and with more lines, which is consistent with (4).

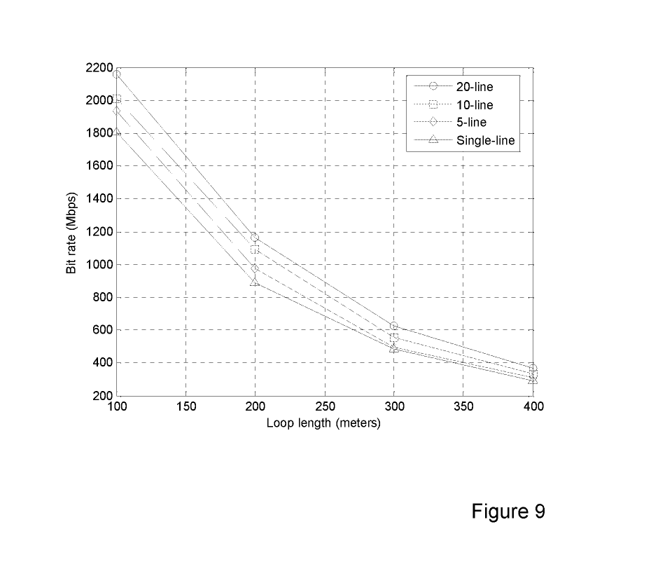

FIG. 9 shows the bit rate reach performance of a coherent transmission system when comprising/utilizing a different number of lines. It can be seen in FIG. 9 that significant capacity gain can be achieved by coherent transmission, especially for loops up to 200 m. The absolute capacity gain gets reduced as loop length increases.

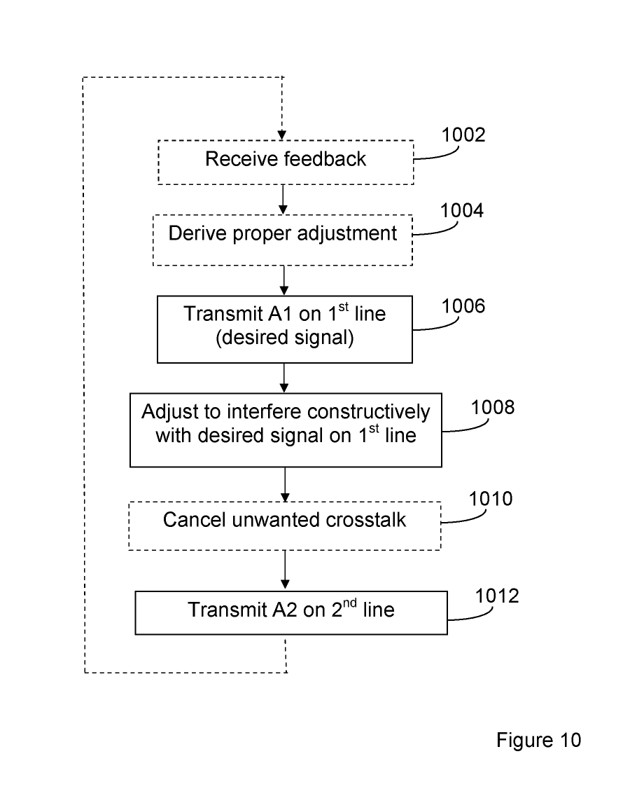

### Exemplifying Procedure Embodiment, FIG. 10

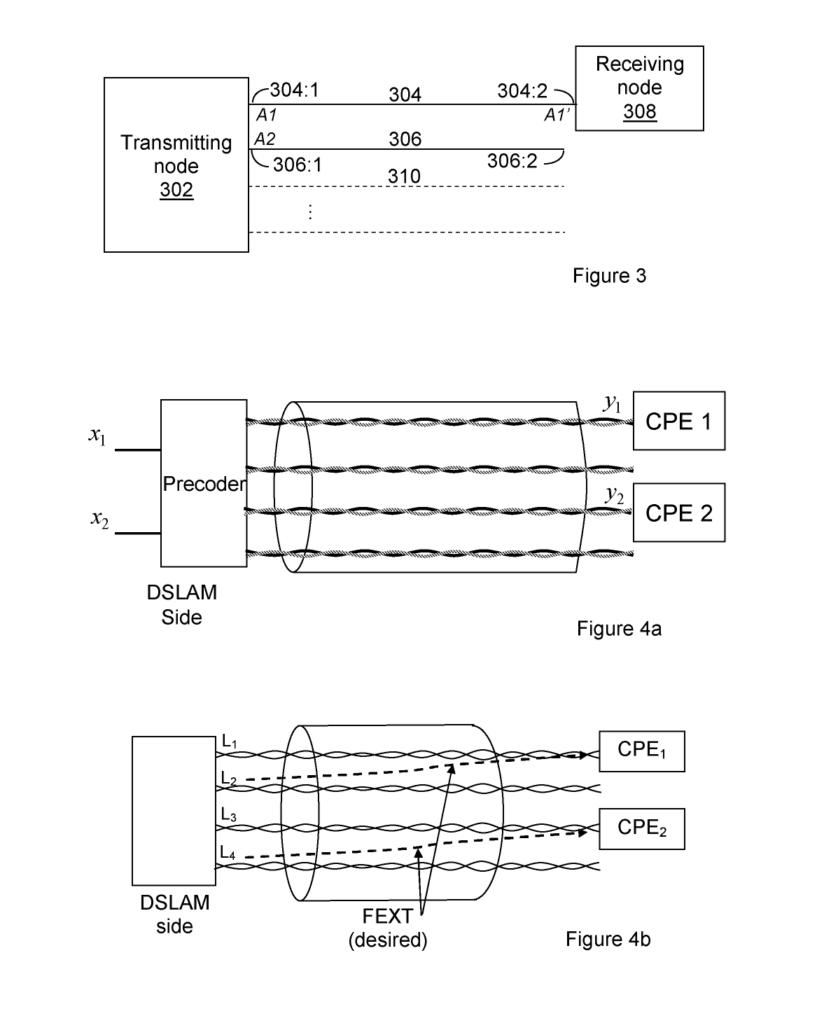

An exemplifying embodiment of the procedure for coherent transmission will be described below, with reference to FIG. 10 (and also supported by references to FIG. 3). The procedure is suitable for use in a transmitting node connected to a number of DSL lines in association with a DSLAM in an xDSL system. Said transmitting node is assumed to be connected to a respective first end 304:1, 306:1 of a first and a second digital subscriber line, 304 and 306. A second end 304:2 of the first line is assumed to be connected to a first receiving node 308, such as a CPE.

The procedure for coherent transmission involves the transmission of a first signal A1 over a first DSL line in an action 1006. The signal A1 comprises e.g. user data destined/intended for a receiving node connected to the first DSL line. Further, a second signal A2 is transmitted over a second DSL line in an action 1012. The second signal A2 is related to the first signal A1. Preferably, A2 comprises part of a scaled version of A1, e.g. for some frequencies. Further, the transmission of the second signal A2 over the second DSL line is adjusted in an action 1008, such that a contribution from the second signal A2 interferes constructively with the signal A1′ at the second end 304:2 of the first line 304. A1′ is the signal A1 after propagation through the first DSL line, i.e. an attenuated, phase-shifted and delayed version of A1, further comprising additive noise and possibly other types of distortion.

The signal A2 could be regarded as a signal comprising only the information which will result in the intended constructive crosstalk to the first line, e.g. a part of the information comprised in the signal A1. With such a definition, a “total” signal transmitted on the second line could comprise other signal components than A2.

The contribution from the second signal A2, which is to interfere constructively with the signal A1′ at the second/far end of the first line, is primarily intended to be crosstalk related to the second signal A2 from the second line 306 to the first line 304. However, the contribution could also, in some embodiments, be a more direct signal, as previously described. For the contribution from the second signal A2 to be of more direct character than crosstalk, the second line could be arranged to be e.g. in physical contact with the first line, by e.g. being connected to the same port of the first receiving node as the first line.

However, the second line is more likely not to be connected to the first receiving node, but to be connected e.g. to a second receiving node, such as a CPE; to a plain old telephone, or, not to be connected to any receiving equipment at all (idle). The second line could alternatively be connected to a second port of the first receiving node.

The adjusting of the transmission of the signal A2 over the second DSL line is based on knowledge of/information on the crosstalk channel from the second line to the first line. Such information could be obtained e.g. by receiving feedback from the first receiving node in an action 1002. The feedback could be of the same type as the feedback according e.g. to the vectoring standard. Such feedback is, or will be, available in many DSL systems, and would therefore not necessarily need to be especially obtained or generated for the purpose of coherent transmission. In some embodiments, such as e.g. in systems using TDD, such information could alternatively be derived from upstream communication received at the transmitting node. The proper precoder coefficients for the adjusting of the transmission of A2 over the second DSL line may be derived e.g. in an action 1004. By use of the feedback or upstream information, the crosstalk channel can be estimated. Then, the precoder coefficients can be calculated according to the estimated channel coefficients. Adaptive algorithms such as LMS (Least Mean Square) could be used to update the precoder coefficients.

The procedure for coherent transmission could also comprise cancellation of unwanted interference to the first DSL line, such as crosstalk from DSL lines not being part of the same coherent transmission system. Such unwanted crosstalk could be cancelled by use of vectoring, e.g. in an action 1010, which could be integrated with the action 1008 of adjusting the transmission in order to achieve constructive interference.

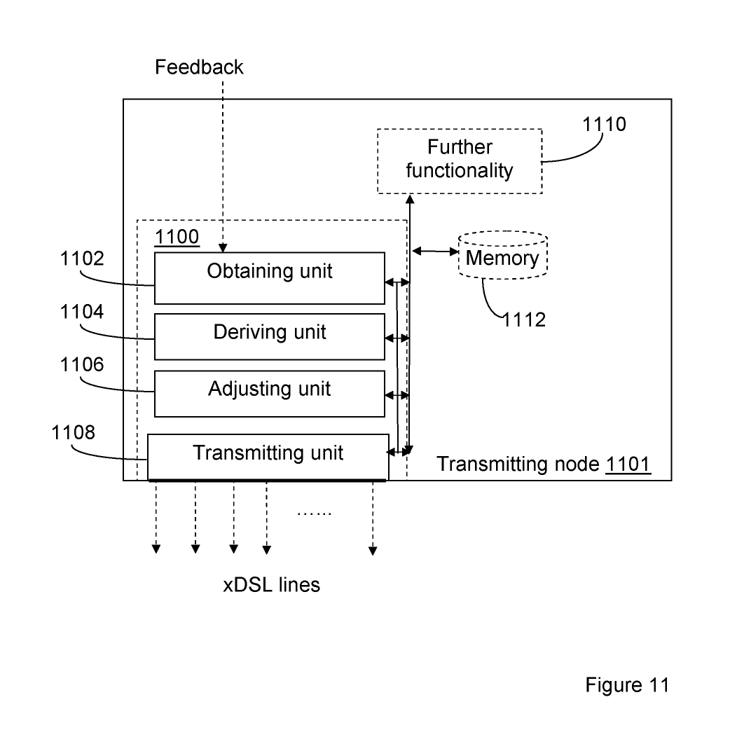

### Exemplifying Node Embodiment, FIG. 11

Below, an exemplifying transmitter node 1101, adapted to perform the above described procedure for coherent transmission will be described with reference to FIG. 11. The transmitter node is connectable to a respective first end of a number of DSL lines and suitable for use in an xDSL system in association with a DSLAM. Said transmitting node is assumed to be connectable to a respective first end 304:1, 306:1 of a first and a second digital subscriber line, 304 and 306. A second end 304:2 of the first line is assumed to be connected to a first receiving node 308, such as a CPE.

The part of the transmitter node which is adapted for enabling the performance of the above described procedure is illustrated as an arrangement 1100, surrounded by a dashed line. The transmitter node may further comprise other functional units 1110, such as e.g. receivers and codecs, and may further comprise one or more storage units 1112.

The transmitter node 1101, and/or the arrangement 1100, could be implemented e.g. by one or more of: a processor or a micro processor and adequate software, a Programmable Logic Device (PLD) or other electronic component(s)/processing circuit(s) configured to perform the actions mentioned above.

The transmitter node is illustrated as comprising an obtaining unit 1102, adapted to receive e.g. feedback from another node and/or the result of measurements on upstream communication. Alternatively, some other unit comprised in the transmitter node may be adapted to receive/derive such information, or, some unit comprised in the transmitter node may already be capable of receiving or deriving such information.

Further, the transmitting node is illustrated as comprising a deriving unit 1104, adapted to derive the correct adjustment to be subjected to a signal to be transmitted over a DSL line in order to achieve a contribution which adds constructively to a direct signal on another DSL line. For example, the appropriate coefficients for a precoder to be used on the signal to be transmitted could be derived.

The transmitter node comprises an adjusting unit 1106, which is adapted to adjust the transmission of the second signal A2 on the second line such that a contribution from the second signal A2 interferes constructively with the signal A1′ at the second/far end of the first line. Preferably, the adjustment is performed by use of a precoder comprising coefficients, which are applied to the signal to be transmitted on the second line. The adjustment unit could be a precoder. The transmission on each tone or a subset of tones on the second DSL line could be subjected to a respective coefficient of a precoder matrix. The adjustment could be performed in a predefined frequency interval, such as e.g. 30-300 MHz. The adjustment unit could further be adapted to derive the correct adjustment to be subjected to the signal to be transmitted, based e.g. on feedback or other information from a far end node.

The transmitter node further comprises a transmitting unit 1108, adapted to transmit a first signal A1 on the first line; and to transmit a second signal A2 on the second line, the second signal A2 being related to the first signal A1. The relation may be that the signals transmitted on a corresponding tone on the first and second DSL line are based on the same data signal. There are times when the signals transmitted on the first and second DSL line could be different or even orthogonal, at least in some frequencies, such as during transmission of non-data signals like pilot or reference signals.

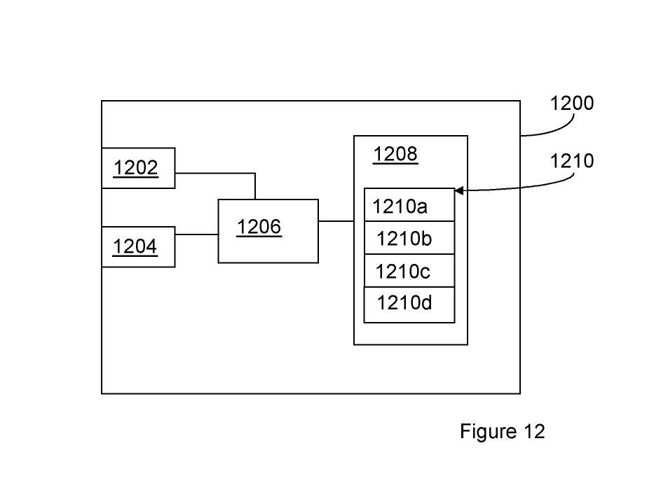

### Exemplifying Arrangement, FIG. 12

FIG. 12 schematically shows an embodiment of an arrangement 1200 in a transmitting node, which also can be an alternative way of disclosing an embodiment of the arrangement in a network node illustrated in FIG. 11. Comprised in the arrangement 1200 are here a processing unit 1206, e.g. with a DSP (Digital Signal Processor). The processing unit 1206 may be a single unit or a plurality of units to perform different actions of procedures described herein. The arrangement 1200 may also comprise an input unit 1202 for receiving signals from other entities, and an output unit 1204 for providing signal(s) to other entities. The input unit 1202 and the output unit 1204 may be arranged as an integrated entity.

Furthermore, the arrangement 1200 comprises at least one computer program product 1208 in the form of a non-volatile memory, e.g. an EEPROM (Electrically Erasable Programmable Read-Only Memory), a flash memory and a hard drive. The computer program product 1208 comprises a computer program 1210, which comprises code means, which when executed in the processing unit 1206 in the arrangement 1200 causes the arrangement and/or the transmitting node to perform the actions e.g. of the procedure described earlier in conjunction with FIG. 10.

The computer program 1210 may be configured as a computer program code structured in computer program modules. Hence, in an exemplifying embodiment, the code means in the computer program 1210 of the arrangement 1200 comprises a transmitting module 1210a for transmitting a first signal on a first DSL line, and a second signal on a second DSL line. The computer program further comprises an adjusting module 1210b for adjusting the transmission of the second signal A2 on the second line such that a contribution from the second signal A2 interferes constructively with a signal A1′ at a second end of the first line (where the signal A1′ represents the signal A1 having propagated through the first line) The computer program 1210 could further comprise other modules, such as an obtaining module 1210c and/or a deriving module 1210d, for providing other desired functionality.

The modules 1210a-d could essentially perform the actions of the flow illustrated in FIG. 10, to emulate the arrangement in a transmitting node illustrated in FIG. 11. In other words, when the different modules 1210a-d are executed in the processing unit 1206, they may correspond to the units 1102-1108 of FIG. 11.

Although the code means in the embodiment disclosed above in conjunction with FIG. 12 are implemented as computer program modules which when executed in the processing unit causes the arrangement and/or network node to perform the actions described above in the conjunction with figures mentioned above, at least one of the code means may in alternative embodiments be implemented at least partly as hardware circuits.

The processor may be a single CPU (Central Processing Unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the transmitter node.

It is to be understood that the choice of interacting units or modules, as well as the naming of the units are only for exemplifying purpose, and nodes suitable to execute any of the methods described above may be configured in a plurality of alternative ways in order to be able to execute the suggested process actions.

It should also be noted that the units or modules described in this disclosure are to be regarded as logical entities and not with necessity as separate physical entities.

As previously described, coherent transmission could be used e.g. for extending the reach and improving the capacity on the lines which are provided with constructive contributions from neighboring DSL lines. Spare DSL lines could be used for creating constructive interference to other DSL lines. For example, in some countries, the POTS network comprises two DSL lines to each potential subscriber, of which one is typically idle.

Further, coherent transmission could be used in mobile backhaul. In mobile backhaul, bonded DSL lines are usually used to increase the backhaul capacity and robustness. Multi-port bonding CPEs are used for bonded DSL lines. Each port of a bonding CPE could be regarded and treated as a single port CPE and coherent transmission could be used to improve e.g. the capacity of each port.

Further, DSL lines which are connected to a receiving node, but which are not presently used, or only used in a certain frequency band, due e.g. to customer activity, subscription, customer equipment, or due to that a user powers down the CPE when not in use, could be used for coherent transmission in frequencies currently unused by a DSL or POTS customer.

Typically, “short” DSL lines or loops have better capacity, e.g. bit rate, than longer DSL lines or loops. By use of coherent transmission, such differences in capacity may be balanced, e.g. by that certain frequencies on the shorter lines are used for creating constructive crosstalk to the longer lines, and thus increasing the capacity in the longer lines in said frequencies. The frequencies used for creating such crosstalk to longer lines could then not be used for communication over the shorter lines, which are thus “deprived” of capacity.

The increase in received power of a desired signal achieved by coherent transmission improves the quality of the desired signal. Therefore, it could, as previously stated, be used for extending reach and/or improving capacity. Alternatively, or in addition, the signal quality improvement could also be used to improve stability.

While the invention has been described with reference to specific example embodiments, the description is in general only intended to illustrate the inventive concept and should not be taken as limiting the scope of the invention. The different features of the exemplifying embodiments above may be combined in different ways according to need, requirements or preference.

1-17. (canceled)

18. A method, in a transmitting node connected to a respective first end of a first digital subscriber line and a second digital subscriber line, a second end of the first digital subscriber line being connected to a first receiving node, the method comprising:
transmitting a first signal (A1) on the first digital subscriber line;
transmitting a second signal (A2) on the second digital subscriber line, the second signal being related to the first signal;
adjusting the transmitting of the second signal on the second digital subscriber line such that a contribution from the second signal interferes constructively with a signal (A1′) at the second end of the first digital subscriber line, where the signal A1′ represents the first signal A1 having propagated through the first digital subscriber line.

19. The method of claim 18, wherein the contribution from the second signal is crosstalk, related to the second signal, from the second digital subscriber line to the first digital subscriber line.

20. The method of claim 18, wherein the adjusting the transmitting of the second signal is performed by use of precoding.

21. The method of claim 18, wherein the first signal and the second signal at least partly comprise the same information.

22. The method of claim 18:
wherein the second signal is transmitted using at least one sub-carrier on the second digital subscriber line;
wherein the contribution from the second signal interferes constructively with the signal on a corresponding at least one sub-carrier on the first digital subscriber line.

23. The method of claim 18, wherein a second end of the second digital subscriber line is not connected to the first receiving node.

24. The method of claim 18, wherein a second end of the second digital subscriber line is connected to a second receiving node.

25. The method of claim 18, wherein the adjusting the transmitting of the second signal is based on at least one of:
feedback received from the first receiving node;
upstream communication from the first receiving node.

26. The method of claim 18, further comprising cancelling crosstalk to the first digital subscriber line from communication on a third line connected to the transmitting node.

27. The method of claim 26, wherein the crosstalk is cancelled by use of vectoring.

28. A transmitting node for digital subscriber lines, connectable to a respective first end of at least a first digital subscriber line and a second digital subscriber line, the transmitting node comprising:
a transmitting circuit configured to:
transmit a first signal (A1) on the first digital subscriber line;
transmit a second signal (A2) on the second digital subscriber line, the second signal being related to the first signal;
an adjusting circuit configured to adjust the transmission of the second signal on the second digital subscriber line such that a contribution from the second signal interferes constructively with a signal (A1′) at the second end of the first digital subscriber line, where the signal A1′ represents the first signal A1 having propagated through the first digital subscriber line.

29. The transmitting node of claim 28, where the contribution from the second signal is crosstalk, related to the second signal, from the second digital subscriber line to the first digital subscriber line.

30. The transmitting node of claim 28, wherein the transmitting circuit is configured to transmit the second signal on at least one sub-carrier on the second digital subscriber line.

31. The transmitting node of claim 28, wherein the adjusting circuit is configured to base the adjustment of the transmission of the second signal on at least one of:
feedback received from a first receiving node connected to the second end of the first digital subscriber line;
upstream communication from a first receiving node connected to the second end of the first digital subscriber line.

32. The transmitting node of claim 28, wherein the adjusting circuit is configured to function as precoder.

33. The transmitting node of claim 28, wherein the transmitting node is configured to cancel crosstalk to the first digital subscriber line from communication on a third line connected to the transmitting node.

34. The transmitting node of claim 33, wherein the transmitting node is configured to cancel the crosstalk by use of vectoring.
